(19) United States
(12) Patent Application Publication
(10) Pub. No.: US 2017/0066668 A1
(43) Pub. Date: Mar. 9, 2017

(54) HIGHLY EFFECTIVE SEWAGE TREATMENT BASED ON REGULATION AND CONTROL OF DIRECTED ELECTRON FLOW AND APPARATUS THEREOF

(71) Applicant: TONGJI UNIVERSITY, Shanghai (CN)

(72) Inventors: Zhiwei WANG, Shanghai (CN); Jinxing MA, Shanghai (CN); Kaili YAN, Shanghai (CN); Mei CHEN, Shanghai (CN); Wei SHAO, Shanghai (CN); Jian LIU, Shanghai (CN); Xuanbo WANG, Shanghai (CN); Chang ZHANG, Shanghai (CN); Zhichao WU, Shanghai (CN); Qiaoying WANG, Shanghai (CN)

(21) Appl. No.: 15/357,678

(22) Filed: Nov. 21, 2016

(30) Foreign Application Priority Data
Feb. 17, 2016 (CN) 201610088208.2

(51) Int. Cl. C02F 3/00; H01M 8/16; C02F 3/28; C02F 3/14; C02F 3/12; C02F 3/30

(52) U.S. Cl. CPC C02F 3/005; C02F 3/1268; C02F 3/305; C02F 3/2806; C02F 3/14; H01M 8/16; C02F 2101/16

(57) ABSTRACT

This present disclosure relates to a highly effective sewage treatment based on regulation and control of directed electron flow and apparatus thereof The apparatus includes an anaerobic fermentation electron generation chamber, a heterotrophic-autotrophic denitrification chamber and an aerobic membrane separation chamber. Low concentrated organic sewage is introduced into anaerobic fermentation electron generation chamber; then, particulate and partly dissolved organic substances are intercepted and absorbed by carrier materials; and extracellular currents generated by microorganism reaction are used in following autotrophic denitrification processing. Micro-/ultra-membrane separation processing is used to improve operation load and solid-liquid separation effect of sewage treatment and thereby effluent could meet the high recycling standards. The directed electron flow is regulated and controlled to enhance nutrients' removal and to reduce sludge yield and fouling rate of membrane. The sewage treatment could efficiently treat low concentrated organic sewage at normal temperature (>15° C.) and dramatically decrease energy consumption.

### FIELD OF THE INVENTION

This present disclosure relates to water and sewage treatment, more specifically, to highly effective sewage treatment based regulation and control of directed electron flow and apparatus thereof.

### BACKGROUND OF THE INVENTION

Domestic environmental issues have become more severe along with the development of social economy in recent years. Water pollution has been one of greatest restrictions for domestic social economy development. Thus, the stricter nutriment emission standards are formulated to restrain further eutrophication of receiving water. Nitrogen as a key pollutant is attracting increasing attentions. It's very important for eutrophication restriction and water environment improvement to decrease emission of nitrogen from urban sewage. How to remove nitrogen with high efficiency is one of toughest problems in urban sewage treatment at present.

Bio-denitrification processing usually includes three steps: ammoniation of organic nitrogen, nitrification of ammonia nitrogen and denitrification of nitrate. Front-denitrification or post-denitrification is usually employed in traditional bio-denitrification process. Denitrification of A2/O process often happens in an aerobic reaction zone and an anoxic reaction zone. Nitrate and nitrite are produced by nitrification in the aerobic reaction zone and then are flowed back to the anoxic reaction zone for denitrification aiming to remove nitrogen. However, large amount of readily biodegradable organic substances are removed after the aerobic reaction resulting in lack of carbon source during the following anoxic reaction, results low efficiency of denitrification. To solve these problems mentioned above, methods of introducing external carbon source are proposed. Chengwen WANG developed a method by taking landfill leachate as carbon source for treatment of urban wastewater with low carbon-nitrogen ratio (Publication number is CN101575140), however, cost of external carbon source is raised and more surplus sludge is produced leading to increase costs of the sludge treatment. Methods to improve denitrification efficiency are also provided. Jun MA provides a method to enhance denitrification and phosphorous removal of urban wastewater (Publication number is CN101575159); Chengqiang WU provides an integrated bio-denitrification system and sewage treatment method thereof (Publication number is CN103613196); Xia HUANG provides a denitrification and phosphorous removal method to enhance endogenous denitrification of bio-membrane reactor and apparatus thereof (Publication number is CN101279794) etc.

Among all existing technical schemes mentioned above, electro-chemical assisting methods are the most inspiring. Huajun FENG provides a bio-electrochemical denitrification reactor (Publication number is CN101857309), in which heterotrophic denitrification is substituted or partly substituted with hydrogen autotrophic denitrification to achieve simultaneous autotrophic nitration-denitrification to remove nitrogen. Chao LI provides an interactive tri-chambered equipment with bio-fuel cell and application method thereof for wastewater denitrification (Publication number is CN103872368), in which reduction of electrodes are introduced and denitrification electrons are supplied by cathode and organic carbon microorganism. In Li's scheme, autotrophic- and heterotrophic-denitrification are carried on at the same time to make up the shortage of carbon source. By using the electro-chemical methods, electrons are provided by decomposing organic substances, and nitrates and nitrites are used as electron acceptors to process autotrophic-denitrification, subsequently solving the problems of carbon source insufficient. However, traditional electro-chemical methods have their limitations on removal of particulate organic substances, pollutant concentration could not reach limit value of water recycling standard. Meanwhile, the requirement for post-treatment units in the traditional electro-chemical methods also restricts the wide applications of these treatment methods.

Membrane bioreactors (MBRs) are a new sewage treatment technology of combination of membrane separation and biological treatment. MBRs play an increasingly important role in sewage treatments and recycle processing due to excellent water quality, low space occupation and low Sludge yield.

### SUMMARY OF THE INVENTION

Based on the existing schemes mentioned above, in this present disclosure a bio-electro-chemical method to regulate and control organic substances' degradation and denitrification processing in MBRs is provided. A sewage treatment technology based on said highly effective regulation and control of directed electron flow and an apparatus thereof is employed to treat low concentrated urban wastewater. Organic substances in low concentrated urban wastewater are converted into electric power through regulation and control of an electron flow direction in reactions so as to mitigate membrane fouling and reduce energy consumption and Sludge yield; meanwhile, an autotrophic-denitrification processing and a heterotrophic denitrification processing are carried on at the same time in the apparatus based on regulation and control of directed electron flows according to this present disclosure with better total nitrogen removal rate, sewage treatment effect and technical economy.

### BRIEF DESCRIPTION OF THE DRAWINGS

FIG. 1 is schematic diagram of a highly effective sewage treatment apparatus based on regulation and control of directed electron flows according to this present disclosure, wherein:

1—water inlet system, 2—anaerobic fermentation electron generation chamber, 3—heterotrophic-autotrophic denitrification chamber, 4—aerobic membrane separation chamber, 5—punched plate, 6—outer circuit and external resistance, 7—aeration system, 8—membrane module, 9—water outlet system, 10—back flow pipe system, 11—automatic feeding device.

### DETAILED DESCRIPTION OF THE INVENTION

This present disclosure aims to provide highly effective sewage treatment methods and apparatus thereof based on regulation and control of directed electron flows for purifying low concentrated organic wastewater. By using the scheme according to this present disclosure, total amount of nitrogen and organic substances in sewage are effectively removed; Sludge yield is dramatically decreased to mitigate membrane fouling; and an electric power is generated during sewage treatment processing to make up energy consumption thereby to reduce cost.

The technical scheme according to this present disclosure is briefly described as following steps:

(1) Sewage is introduced into an anaerobic fermentation electron generation chamber through a water inlet system, and particulate and part of the dissolved organic substances in the sewage are intercepted and absorbed by porous conductive carrier materials in said anaerobic fermentation electron generation chamber; the organic substances are converted into electrons by microorganism; the treated sewage is introduced into a heterotrophic-autotrophic denitrification chamber and an aerobic membrane separation chamber in sequence;

(2) In said heterotrophic-autotrophic denitrification chamber, the electrons are transmitted from outer circuit formed between said anaerobic fermentation electron generation chamber and said heterotrophic-autotrophic denitrification chamber, and the electrons are utilized together with the residual organic substances in said treated solution after said step (1) by microorganisms thorough the heterotrophic-autotrophic denitrification pathway to remove nitrates or nitrites in the mixed liquor back-flowing from the aerobic membrane separation chamber;

(3) In the aerobic membrane separation chamber, nitrificating the treated solution from said step (2) with high efficiency; meanwhile, total phosphorus (TP) removal rate is improved due to the addition of chemical phosphorous removal reagent with automatic feeding device. The water with excellent quality is gained by suction of a membrane module.

According to the scheme of this present disclosure, sludge yield is very low and the sludge retention time (SRT) of apparatus thereof could reach to 150˜250 days. Fouling rate of the membrane module of said aerobic membrane separation chamber is very low, therefore cleaning period of membranes could reach more than four months when flux is 20˜30 L/(m²·h).

According to the scheme of this present disclosure, porous conductive carrier materials in said anaerobic fermentation chamber are chosen from any one of carbon blanket, carbon balls or carbon cloths characterized in porous conductivity and large specific surface area for microorganism growth. As soon as a bio-membrane is generated on the surface of these carrier materials, interception and filtration of fine organic substances particles are improved; the absorbed organic particles are finally converted into electrons by microorganism and then the electrons serve as electron source of following autotrophic denitrification process.

According to the scheme of this present disclosure, the organic substances of inlet water in step 1 are converted into electrons and then the electrons are utilized in following denitrification processing. Meanwhile, nitrogen nutrients are removed during nitration-denitrification processing, and phosphorus nutrients are removed by bio-chemical phosphorus removal processing. Application of the membrane separation processing ensures excellent solid-liquid separation efficiency. By treating the normal urban or rural wastewater according to this present disclosure, the quality of effluent is stable, and could reach the first grade A standards of national disposal standard.

The sewage treatment method according to this present disclosure are especially suitable to purify low concentrated urban wastewater (chemical oxygen demand (COD) is 200˜550 mg/L, ammoniacal nitrogen (NH₄⁺—N) is 20˜55 mg/L, total nitrogen (TN) is 20˜70 mg/L), wherein, COD, NH₄⁺—N and TN concentrations of effluent could reach first grade A standards of <Integrated Wastewater Discharge Standard>. According to this present disclosure, the electron flow direction is regulated and controlled to enhance nitrogen removal rate and reduce sludge yield, and thus to elongate SRT which could be more than 150 days, therefore, membrane fouling rate could be dramatically decreased.

A highly effective sewage treatment apparatus based on regulation and control of directed electron flow is provided in this present disclosure comprising: a water inlet system 1; an anaerobic fermentation electron generation chamber 2; a heterotrophic-autotrophic denitrification chamber 3; and an aerobic membrane separation chamber 4 connected in sequence; a punched plate 5 is displaced at bottom of said anaerobic fermentation electron generation chamber 2 to separate said anaerobic fermentation electron generation chamber 2 and said heterotrophic-autotrophic denitrification chamber 3; porous conductive materials are padded in said anaerobic fermentation electron generation chamber 2; a carbon brush is suspended as electrode in said heterotrophic-autotrophic denitrification chamber 3; an outer circuit forming between said anaerobic fermentation electron generation chamber 2 and said heterotrophic-autotrophic denitrification chamber 3 is connected by an external resistance 6; an aeration system 7 and a membrane module 8 are arranged in said aerobic membrane separation chamber 4; said membrane module 8 is connected to a water outlet through a membrane effluent pump and an outlet system 9; said aerobic membrane separation chamber 4 is connected to said heterotrophic-autotrophic denitrification chamber 3 through a back flow pump and a back flow pipe system 10; an automatic phosphorous removing agent feeding device 11 is set in said aerobic membrane separation chamber 4.

Beneficial effects of sewage treatment methods according to this present disclosure are as follows:

1. Efficiency of the sewage treatment and water quality of effluent according to this present disclosure are both greatly improved, because heterotrophic denitrification and autotrophic denitrification are performed in the apparatus at the same time to improve removal rate of TN; meanwhile, a chemical phosphorus removing treatment is combined with bio-phosphorus removing treatment to enhance phosphorus removal rate.

2. The membrane fouling is mitigated by reducing concentration of sludge mixture because organic substances of inlet are converted into electric power, thus inhibiting following propagation of heterotrophic bacteria.

3. Energy consumption is decreased because electric power could be generated during the sewage treatment processing. Compared to traditional MBRs, energy consumption of said sewage treatment method is reduced by 20˜30%.

4. SRT is elongated and less residual sludge is discharged.

5. It's convenient and effective for the apparatus according to this present disclosure to be integrated with an existing sewage treatment processing to update and reform the existing sewage treatment processing, because its cost of infrastructure and operation is low and the apparatus occupied construction area is limited.

### EMBODIMENTS

The present invention will be further described below with reference to specific examples. However, these examples should not be construed to limiting the scope of the present invention.

### Embodiment I

A method of sewage treatment based on regulation and control of directed electron flows comprises following steps:

1) Sewage is introduced into an anaerobic fermentation electron generation chamber through a water inlet system, and particulate and part of the dissolved organic substances in the sewage are intercepted and absorbed by porous conductive carrier materials in said anaerobic fermentation electron generation chamber; the organic substances are converted into electrons by microorganism; the treated sewage is introduced into a heterotrophic-autotrophic denitrification chamber and an aerobic membrane separation chamber in sequence;

2) In said heterotrophic-autotrophic denitrification chamber, the electrons are transmitted from outer circuit formed between said anaerobic fermentation electron generation chamber and said heterotrophic-autotrophic denitrification chamber, and utilized together with the residual organic substances by microorganisms thorough the heterotrophic-autotrophic denitrification pathway. Thereby, nitrates or nitrites in the mixed liquor back-flowing from the aerobic membrane separation chamber are removed;

3) In the aerobic membrane separation chamber, the nitrification is highly efficient; meanwhile, TP removal rate is improved due to the addition of chemical phosphorus removal reagent with automatic feeding device. The effluent with excellent quality is gained by suction of a membrane module.

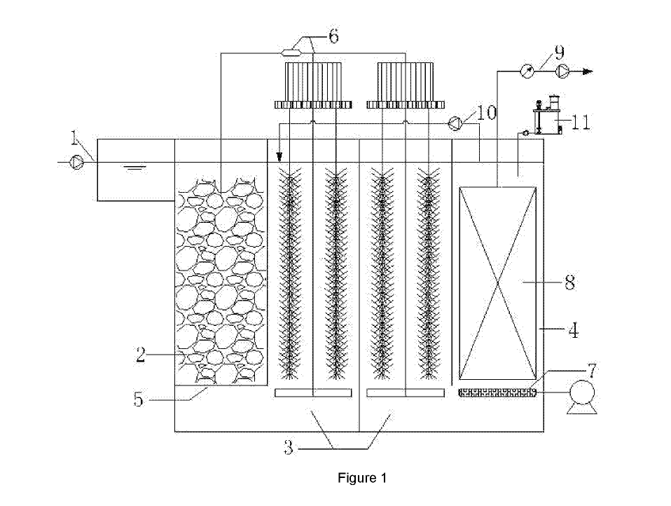

An apparatus using the sewage treatment method mentioned above according to this present closure also provided herein comprises shown in FIG. 1: a water inlet system 1; an anaerobic fermentation electron generation chamber 2; a heterotrophic-autotrophic denitrification chamber 3; and an aerobic membrane separation chamber 4; a punched plate 5 is displaced at bottom of said anaerobic fermentation electron generation chamber 2 to separate said anaerobic fermentation electron generation chamber 2 and said heterotrophic-autotrophic denitrification chamber 3; porous conductive materials are padded in said anaerobic fermentation electron generation chamber 2; a carbon brush is suspended as electrode in said heterotrophic-autotrophic denitrification chamber 3; an outer circuit forming between said anaerobic fermentation electron generation chamber 2 and said heterotrophic-autotrophic denitrification chamber 3 is connected by an external resistance 6; an aeration system 7 and a membrane module 8 are arranged in said aerobic membrane separation chamber 4; said membrane module 8 is connected to a water outlet through a membrane effluent pump and an outlet system 9; said aerobic membrane separation chamber 4 is connected to said heterotrophic-autotrophic denitrification chamber 3 through a back flow pump and a back flow pipe system 10; an automatic phosphorus removing agent feeding device 11 is set in said aerobic membrane separation chamber.

An effluent from sand basin of a southern city's urban sewage treatment plant is purified by the sewage treatment method according to this present disclosure. The operating temperature is higher than 15° C.; COD concentration of the inlet water is 408.7±141.0 mg/L; NH₄⁺—N concentration is 40.7±8.6 mg/L; and TN concentration is 58.3±7.8 mg/L. In this sewage treatment processing, the hydraulic retention time (HRT) is 15.3 h; and the membrane flux is 20 L/(m²·h). In the effluent from this sewage treatment according to this present disclosure, the average removal rate of COD is (95.4±1.4)%; the average removal rate of NH₄⁺—N is (99.1±1.1)%; and the average TN removal rate is (78.2±5.3)%. During this sewage treatment processing, the cleaning period of membrane components maintains above 130 days; and the maximum power density could reach 98.4 mW/m².

### Embodiment II

A rural domestic sewage is purified by said sewage treatment method and apparatus thereof in EMBODIMENT I. In the influent, COD concentration is 312.7±20.9 mg/L; NH₄⁺—N concentration is 27.7±5.8 mg/L; TN concentration is 30.3±7.8 mg/L; and TP concentration is 8.1±3.2 mg/L. In this sewage treatment processing, HRT is 13.7 h; the membrane flux is 22 L(m²·h); and the c feeding dosage of poly-ferric chloride (PFC) is 12 mg/L. In the effluent, the average removal rate of COD is (96.3±1.0)%; the average removal rate of NH₄⁺—N is (99.2±0.9)%; the average removal rate of TN is (92.2±2.4)%; and the average removal rate of TP is (87.1±4.2)%. During this sewage treatment processing, the cleaning period of membrane components maintains above 150 days; and the maximum power density could reach 94.2 mW/m².

### Embodiment III

A sewage from community is purified by said sewage treatment method and apparatus thereof in EMBODIMENT I. In the influent, COD concentration is 320.7±70.6 mg/L; NH₄⁺—N concentration is 46.1±7.2 mg/L; and TN concentration is 55.6±8.2 mg/L. In this sewage treatment, HRT is 14 h; and the membrane flux is 18 L/(m²·h). In the effluent, the average removal rate of COD is (96.9±2.4)%; the average removal rate of NH₄⁺—N is (98.5±1.2)%; and the average removal rate of TN is (84.7±3.5)%. During this sewage treatment processing, the cleaning period of membrane components maintains above 150 days; and the maximum power density could reach 91.9 mW/m².

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods and techniques that are insubstantially different from those described above and/or in the appended claims are also intended to be within the scope of the disclosure.

1. A sewage treatment method based on regulation and control of directed electron flow, which is characterized in comprising the steps of:
(1) Introducing sewage into an anaerobic fermentation electron generation chamber through a water inlet system; intercepting and absorbing particulate and part of the dissolved organic substances in said sewage by porous conductive carrier materials in said anaerobic fermentation electron generation chamber; converting the organic substances are converted into electrons by microorganism; then introducing the treated solution into a heterotrophic-autotrophic denitrification chamber and an aerobic membrane separation chamber in sequence;
(2) In said heterotrophic-autotrophic denitrification chamber, transmitting electrons from outer circuit formed between said anaerobic fermentation electron generation chamber and said heterotrophic-autotrophic denitrification chamber; utilizing the electrons transmitted with residual organic substances in said treated solution after said step (1) by microorganisms through the heterotrophic-autotrophic denitrification pathway to remove nitrates or nitrites of a sludge mixture back-flowing from said aerobic membrane separation chamber;
(3) In said aerobic membrane separation chamber, nitrificating the treated solution from said step (2) with high efficiency; meanwhile, TP removal rate is improved due to addition of chemical phosphorus removal reagent with automatic feeding device; finally, water with excellent quality is gained by suction of a membrane module.

2. A sewage treatment method based on regulation and control of directed electron flow according to claim 1, which is characterized in: a SRT could be 150˜250 days; a permeation flux of said membrane module is set to be 20˜30 L/(m²·h) in said aerobic membrane separation chamber.

3. A sewage treatment method based on regulation and control of directed electron flow according to claim 1, which is characterized in: said porous conductive carrier materials in said anaerobic fermentation electron generation chamber are chosen from one of carbon blankets, carbon balls or carbon cloths configured for porous conductivity and large specific surface area for microorganism growth; a bio-membrane is generated on the surface of said porous conductive carrier materials to further improve interception and filtration of fine particulate organic substances in introduced solution; said fine particulate organic substances are finally converted into electrons by said electro-microorganism to be employed in following autotrophic denitrification processing.

4. A sewage treatment method based on regulation and control of directed electron flow according to claim 1, which is characterized in: of the said step (1) introduced sewage, organic substances are converted into electrons which are then employed in following denitrification processing; nitrogen nutrients are removed in nitrification-denitrification processing; phosphorus nutrients are removed by bio- and chemical phosphorus removal agent.

5. A sewage treatment method based on regulation and control of directed electron flow according to claim 1, which is characterized in: of the said step (1) introduced sewage, COD is 200˜550 mg/L; NH₄⁺—N is 20˜55 mg/L; and TN is 20˜70 mg/L.

6. An apparatus employing the sewage treatment method based on regulation and control of directed electron flow according to claim 1, which is characterized in comprising:
a water inlet system (1), an anaerobic fermentation electron generation chamber (2), a heterotrophic-autotrophic denitrification chamber (3), and an aerobic membrane separation chamber (4) connected in sequence; wherein,
a punched plate (5) is displaced at bottom of said anaerobic fermentation electron generation chamber (2) to separate said anaerobic fermentation electron generation chamber (2) and said heterotrophic-autotrophic denitrification chamber (3); porous conductive materials are padded in said anaerobic fermentation electron generation chamber (2); a carbon brush is suspended as electrode in said heterotrophic-autotrophic denitrification chamber (3); an outer circuit forming between said anaerobic fermentation electron generation chamber (2) and said heterotrophic-autotrophic denitrification chamber (3) is connected by an external resistance (6); an aeration system (7) and a membrane module (8) are arranged in said aerobic membrane separation chamber (4); said membrane module (8) is connected to a water outlet through a membrane effluent pump and an outlet system (9); said aerobic membrane separation chamber (4) is connected to said heterotrophic-autotrophic denitrification chamber (3) through a back flow pump and a back flow pipe system (10); an automatic phosphorus removing agent feeding device (11) is set in said aerobic membrane separation chamber (4).
